(19) United States
(12) Patent Application Publication
(10) Pub. No.: US 2014/0029002 A1
(43) Pub. Date: Jan. 30, 2014

(54) ADJUSTABLE INTERSURFACE SPACING FOR SURFACE ENHANCED RAMAN SPECTROSCOPY

(71) Applicants: Shih-Yuan Wang, Palo Alto, CA (US); Zhiyong Li, Foster City, CA (US); Alexandre M. Bratkovski, Mountain View, CA (US); Gary Gibson, Palo Alto, CA (US); Huei Pei Kuo, Cupertino, CA (US); Zhang-Lin Zhou, Palo Alto, CA (US); Steven J. Barcelo, Mountain View, CA (US); Ansoon Kim, Mountain View, CA (US); R Stanley Williams, Portola Valley, CA (US)

(72) Inventors: Shih-Yuan Wang, Palo Alto, CA (US); Zhiyong Li, Foster City, CA (US); Alexandre M. Bratkovski, Mountain View, CA (US); Gary Gibson, Palo Alto, CA (US); Huei Pei Kuo, Cupertino, CA (US); Zhang-Lin Zhou, Palo Alto, CA (US); Steven J. Barcelo, Mountain View, CA (US); Ansoon Kim, Mountain View, CA (US); R Stanley Williams, Portola Valley, CA (US)

(21) Appl. No.: 13/561,561

(22) Filed: Jul. 30, 2012

(51) Int. Cl. G01J 3/44

(52) U.S. Cl. 356/301

(57) ABSTRACT

A sensor for surface enhanced Raman spectroscopy (SERS) sensor includes surfaces and an actuator to adjust an intersurface spacing between the surfaces to contain an analyte and allow the analyte to be released from containment.

### BACKGROUND

Raman spectroscopy is used to study the transitions between molecular energy states when incident photons scatter as a result of their interaction with an analyte (i.e., a species, molecule or, in general, matter being analyzed). The scattered photons have an energy that is shifted in frequency due to two processes: the incident photons excite the analyte to cause the analyte to transition from a certain initial energy state to another (either virtual or real) energy state; and the excited analyte radiates as a dipole source to produce a scattered signal. The analyte radiates under the influence of its environment and molecular structure at a frequency that may be relatively low (called Stokes scattering), or relatively high (called anti-Stokes scattering), as compared to the frequency of the excitation photons.

The Raman spectra of a given analyte have characteristic peaks corresponding to the Raman-active vibrational modes (including bending, stretching, twisting modes), which may be used to identify the analyte. As such, Raman spectroscopy is a useful technique for a variety of chemical or biological sensing applications. However, the intrinsic Raman scattering process is often relatively inefficient. For purposes of improving the efficiency of the above-described excitation and radiation processes, enhancements may be made using surface enhanced Raman spectroscopy (SERS). These enhancements typically include rough metal surfaces, various types of nano-antennas, nanostructures such as nanowires coated with metal, black silicon coated with metal, as well as waveguiding structures.

### BRIEF DESCRIPTION OF THE DRAWINGS

FIG. 1 is a semi-schematic perspective view of a surface enhanced Raman spectroscopy (SERS) sensor according to an example implementation.

FIG. 2 is a cross-sectional view taken along line 2-2 of FIG. 1 illustrating the sensor in an open state before the introduction of an analyte according to an example implementation.

FIG. 3 is a cross-sectional view taken along line 2-2 of FIG. 1 illustrating the sensor in the open state and the introduction of the analyte according to an example implementation.

FIG. 4 is a cross-sectional view taken along line 2-2 of FIG. 1 illustrating a closed state of the sensor in which the analyte is contained within surfaces of the sensor according to an example implementation.

FIG. 5 is a flow diagram depicting a technique to use a SERS sensor having an adjustable intersurface spacing according to an example implementation.

FIGS. 6, 7, 8, 9, 10, 11 and 12 are cross-sectional views of SERS sensors according to further example implementations.

FIG. 13 is a semi-schematic perspective view of waveguides of a SERS sensor according to an example implementation.

FIG. 14 is a cross-sectional view of the SERS sensor of FIG. 13 further illustrating the waveguides according to an example implementation.

### DETAILED DESCRIPTION

Techniques and systems are disclosed herein for purposes of allowing a surface enhanced Raman spectroscopy (SERS) sensor to be used multiple times (used “continuously,” for example). In this manner, in accordance with example implementations that are disclosed herein, a SERS sensor has an adjustable intersurface spacing between opposing enhanced surfaces of the sensor. This adjustable intersurface spacing facilitates the introduction of an analyte (a target species, molecules or in general, matter to be analyzed) inside a region defined between the enhanced surfaces, followed by trapping of the analyte at locations where Raman scattering is greatly enhanced. The adjustable intersurface spacing also facilitates the subsequent removal of the analyte so that the SERS sensor may be reused to analyze another analyte.

In this manner, the spacing between the opposed surface enhanced surfaces may be increased to allow introduction of the analyte between the surfaces and allow the removal or flushing of the analyte from this region. The spacing between the opposing enhanced surfaces may be decreased to bring the enhanced surfaces into relatively close proximity of the analyte (within 10 nanometers (nm) or less, for example) for purposes of plasmonically enhancing the Raman signal that results from incident photons scattering as a result of their interaction with the analyte.

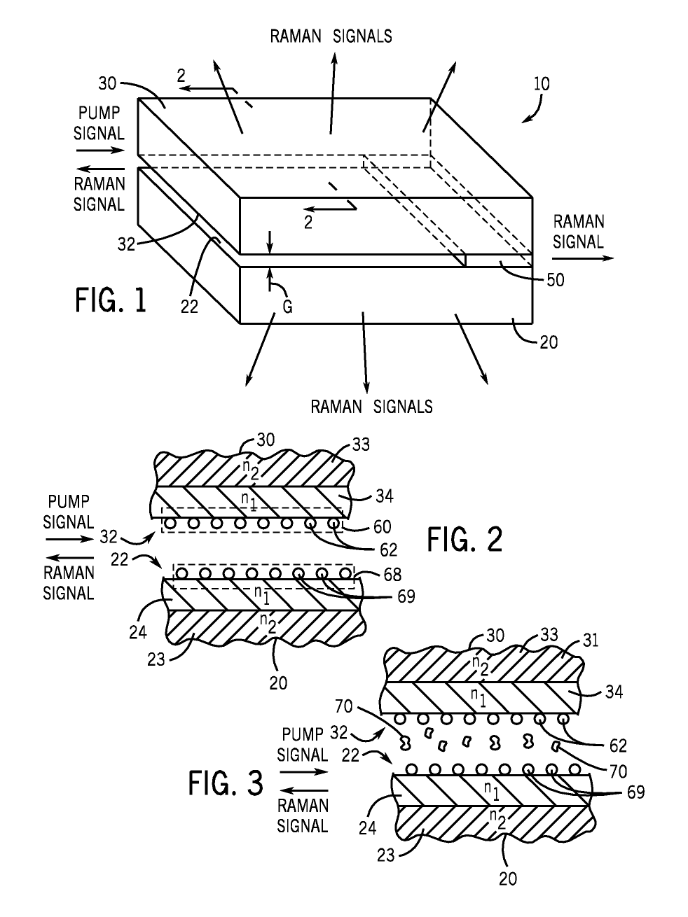

As a more specific example, FIG. 1 depicts a SERS sensor 10 according to an example implementation. It is noted that FIG. 1 depicts a simplified view of the sensor 10 illustrating certain features related to the relative spatial orientations of opposing enhanced surfaces 22 and 32, which are spaced apart by an intersurface spacing G. Thus, the SERS sensor 10 may have many other features, such as waveguides, pump signal enhancements and collection enhancements.

For the example that is depicted in FIG. 1, the sensor 10 includes substrates 20 and 30 upon which are formed the enhanced surfaces 22 and 32, respectively. In this context, by being formed “on” or “upon” the substrate, the enhanced surface is at least partially supported by the substrate, which may or may not involve contact with the substrate.

The substrates 20 and 30 are adjustable, or movable (as described below), with respect to each other to control the intersurface spacing G between the opposing enhanced surfaces 22 and 32. For this example, an actuator 50 of the sensor 10 regulates the intersurface spacing G and may be disposed between the substrates 20 and 30 in accordance with some implementations, as depicted in FIG. 1.

The actuator 50 may be controlled for purposes of manipulating the extent of the intersurface spacing G so that when the intersurface spacing G is relatively wide, an analyte may be introduced between the surfaces 22 and 32. Thereafter, the actuator 50 may be controlled to close, or narrow, the intersurface spacing G to bring the surfaces 22 and 32 closer together to trap, or contain, the analyte between the surfaces 22 and 32. In this manner, the opposing surfaces 22 and 32 are brought in close proximity (less than 10 nm or less, for example) to each other, with the analyte being contained, or trapped, between the surfaces 22 and 32. The actuator 50 may be controlled electrically (piezoelectrically or capacitively), optically, pneumatically (either by pressure or vacuum), mechanically, thermally (using a bimetal, a memory metal or memory polymers) or using a fluidic structure (a structure that uses capillary action or uses the evaporation of fluid to draw surfaces together, as examples).

The surfaces 22 and 32 may be coated with metal or may be made entirely of metal, in accordance with some implementations. In this manner, in the contained, closed state of the sensor 10, plasmonic metals disposed on the surfaces 22 and 32 are in relatively close proximity (less than 10 nm, for example) to the analyte for purposes of plasmonically enhancing a Raman signal that is produced as a result of introduced incident photons (herein called the “pump signal”) interacting with the analyte to produce a corresponding scattered, or Raman, optical signal (herein called the “Raman signal”). A plasmonically enhancing material other than metal (a dielectric, for example) may be used in further implementations.

The substrate 20, 30 may be formed from a transparent material. Non-limiting examples of materials suitable for the substrate 20, 30 include insulators (e.g., glass, quartz, ceramic, alumina, silica, silicon nitride, etc.) and polymeric material(s) (e.g., polycarbonate, polyamide, acrylics, etc.).

As a more specific example, FIG. 2 depicts a semi-schematic cross-sectional view taken along line 2-2 of FIG. 1 for an open state of the sensor 10. In this open state, the intersurface spacing G (see FIG. 1) is sufficiently large enough to allow any remaining analyte from a previous experiment to be flushed from the region between the enhanced surfaces 22 and 32. In this manner, an analyte 70 is physically trapped between the enhanced surfaces 22 and 32 when the intersurface spacing G is decreased, and the widening of the intersurface spacing G allows the analyte 70 to be removed.

For the example implementation that is depicted in FIG. 2, the enhanced surface 22 is formed at least in part by nanostructures 68 that are formed on the substrate 20. In general, the nanostructure 68 includes at least one dimension that is on the nano-scale (from 1 nanometer (nm) to 1000 nm, for example).

As a more specific example, in accordance with example implementations, the nanostructure 68 may be a nanodot 69, and as such, a spatial array of nanodots 69 may be formed on the substrate 20. As further disclosed herein, the nanostructure 68 may be a nanostructure (nanofingers, nanowires and substrates) other than a structure that employs dots.

As also depicted in FIG. 2, in accordance with example implementations, the enhanced surface 32 may be formed at least in part from nanostructures 60, which also may include nanodots 62. As a non-limiting example, the nanodots 62 may be complementarily-arranged with respect to the nanodots 69 (i.e., the nanodots 62 and 69 may be offset, as depicted in FIG. 2). However, in accordance with further implementations, the nanodots 62 and/or the nanodots 69 may be randomly or pseudo-randomly spatially arranged on their respective substrate. The nanodots 62 and 69 may also be arranged so as to register in accordance with some implementations. Thus, many implementations are contemplated, which are within the scope of the appended claims.

As depicted in FIG. 2, in accordance with some implementations, the substrate 20 and/or 30 may be a multiple layer substrate. For example, the substrate 20 may include layers 23 and 24, where the layer 24 is closer to the enhanced surface 22. The refractive index (n₂) of the layer 23 is less than the refractive index (n₁) of the layer 24. In a similar manner, the substrate 30 may include layers 33 and 34, where the layer 34 is closer to the enhanced surface 32 than the layer 33. The layer 33 has a lower refractive index n₂ than the refractive index n₁ of the layer 34. Due to this arrangement, pump light injected into layer 24 will be largely guided in the plane of the substrate, thereby allowing more interaction of the pump with the enhanced surfaces 22 and 32 where the analyte is located, in accordance with some implementations. Furthermore, much of the resulting Raman emission is trapped in the higher index material 24, 34 and propagates in the plane of the substrate 20, 30, allowing efficient collection of these signals at the edges of the substrate.

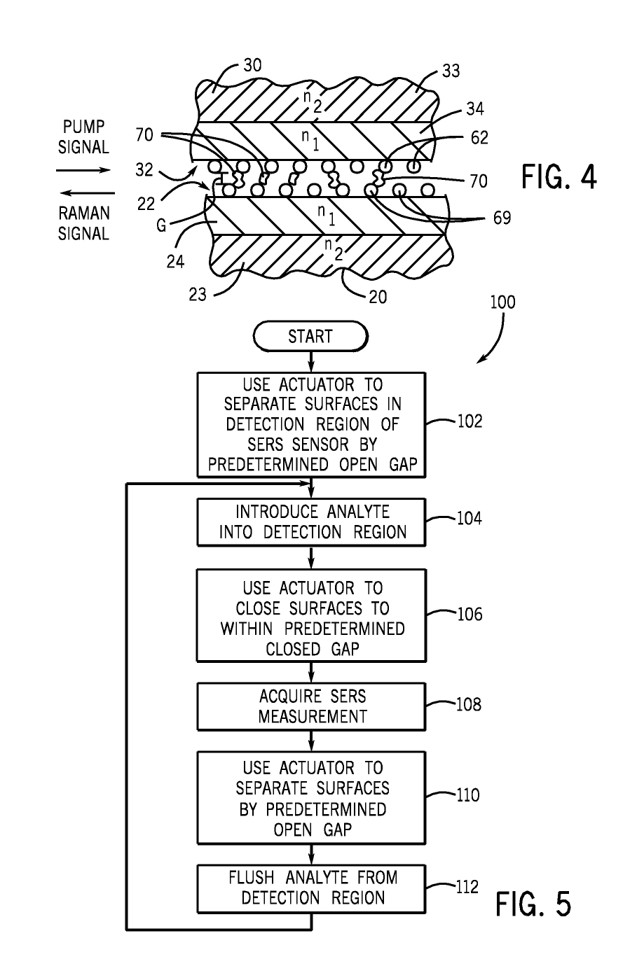

Referring to FIG. 3, in the open state of the sensor 10 (i.e., the state in which the actuator 50 (see FIG. 1) widens the intersurface spacing G), the analyte 70 may be introduced into the region between the enhanced surfaces 22 and 32. Thereafter, as depicted in FIG. 4, the actuator 50 (see FIG. 1) may be controlled to decrease the intersurface spacing G to establish a closed state for the sensor 10. The sensor 10 may include spacers (not shown), such as inert nanostructures/particles, to allow the gap to be close limited by the spacer gap. In the closed state, the analyte 70 is in close proximity to opposing nanodots 62 and 69 of the enhanced surfaces 22 and 32, thereby enhancing the Raman signal. The enhancement of the Raman signal is strongest when the analyte is trapped between two or more plasmonic nanodots as in this case the nanodots behave as nanoantenna. The plasmonic nanostructures/nanodots/nanoparticles may be coated with metal or may be made of metal entirely, metal such as Au, Ag, Pt, Pd, Ni, Cu, Al and/or mixtures and/or alloys of such metals, to name a few. It is noted that a single nanodot may act as an antenna. In this manner, in some implementations, a flat, non-plasmonic surface is disposed on one side and plasmonic nanodots on the other surface, with the analyte trapped between them. At the conclusion of the Raman spectroscopy measurement, the actuator 50 may be controlled to increase the intersurface spacing G to allow the analyte 70 to be removed, or flushed from, the region between the opposing enhanced surfaces 22 and 32.

Thus, referring to FIG. 5, in accordance with some implementations, a technique 100 may be used for repeated (e.g., “continuous”) measurements using the same SERS sensor. The technique 100 includes using (block 102) an actuator of the sensor to separate enhanced surfaces by a predetermined open gap, so that an analyte may be introduced into the region between the enhanced surfaces, pursuant to block 104. The actuator may then be used, pursuant to block 106, to close the enhanced surfaces to within a predetermined closed gap and/or a closed gap. A SERS measurement may then be acquired, pursuant to block 108. The actuator may then be used, pursuant to block 110, to separate the enhanced surfaces by the predetermined open gap so that the analyte may be flushed from the detection region sensor, pursuant to block 112. Upon the flushing the analyte from the sensor, an analyte may be subsequently introduced, and thus, the SERS sensor may be reused, returning control to block 104.

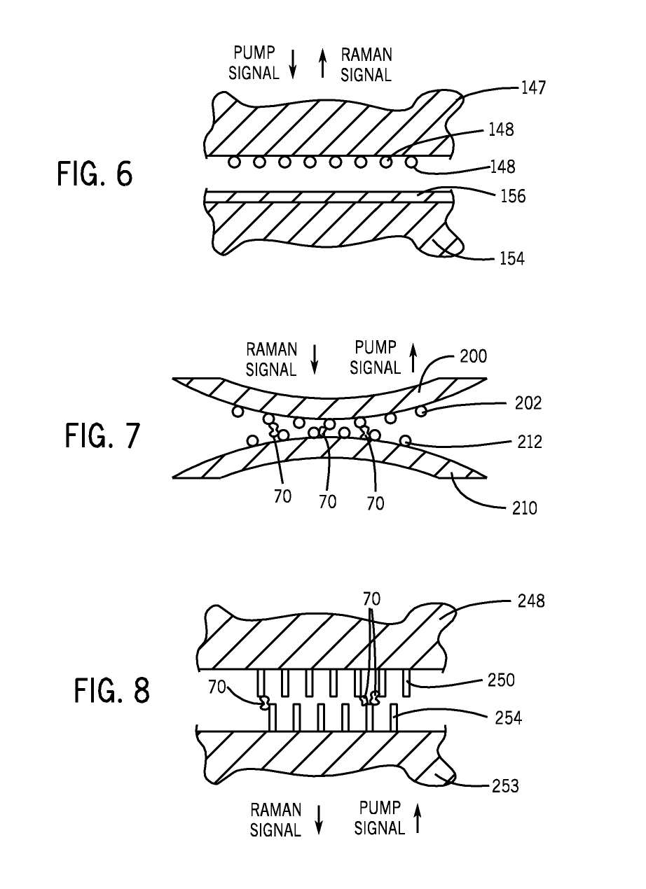

Other implementations are contemplated, which are within the scope of the appended claims. For example, FIG. 6 depicts a further implementation in which a SERS sensor includes substrates 147 and 154, which replace the substrates 30 and 20 (see FIG. 1, for example), respectively. For this arrangement, nanostructures, such as nanodots 148 coated or made with plasmonic metal, are formed on the substrate 147 to form a corresponding enhanced surface. The opposing enhanced surface is formed from a metal layer 156 that is formed on the substrate 154 in lieu of nanostructures. As examples, the metal layer 156 may be a layer of a plasmonic metal, such as (as examples) gold, silver, nickel, copper palladium or platinum.

As another example, opposing parabolic substrates 200 and 210 may be alternatively used, in accordance with further implementations. In this manner, as depicted in FIG. 7, nanodots 202 and 212 are formed on the substrates 200 and 210, respectively for purposes of forming opposing enhanced surfaces.

As another example, FIG. 8 depicts a SERS sensor in which nanowires 250 and 254 are formed on opposing substrates 248 and 253, respectively, to form corresponding opposing enhanced surfaces, the nanowires may be randomly dispersed or positioned in a orderly periodic or aperiodic arrangement. The nanowires 250, 254 may be formed from metals, semiconductors, dielectric materials, polymers that are coated with plasmonic metal, depending on the particular implementation.

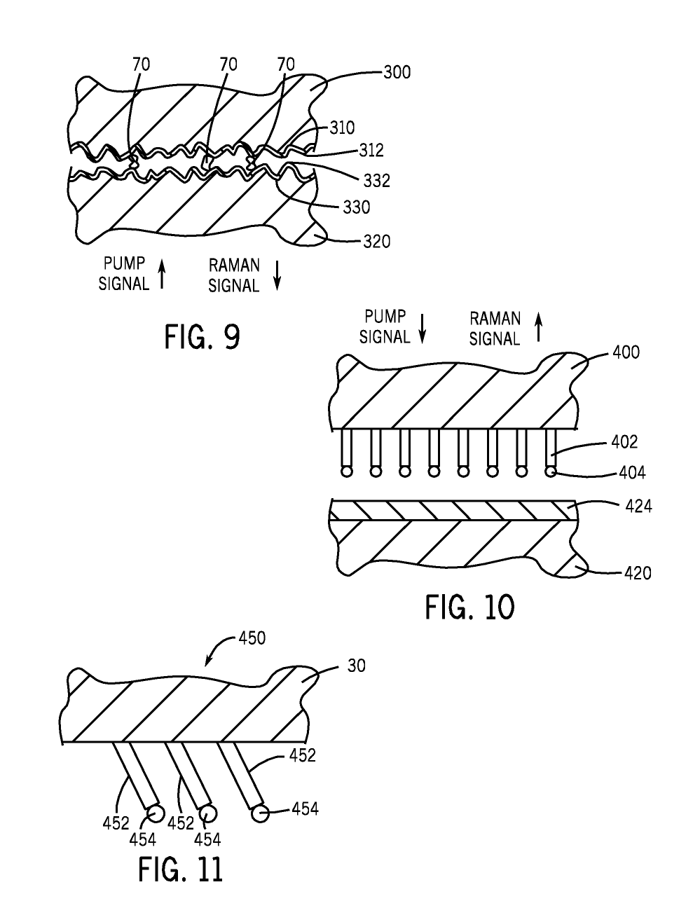

Referring to FIG. 9, in accordance with further implementations, a SERS sensor may include opposing substrates 300 and 320, which have roughened enhanced surfaces 310 and 330, respectively. Moreover, as shown in FIG. 9, in accordance with some implementations, the roughened surfaces 310 and 330 may be coated with a single atomic layer of a plasmonic metal using, for example, atomic layer deposition (ALD), or plasmonic metal film that is semitransparent with thickness less than 100 nm using sputtering, evaporation deposition methods.

As an example of a further implementation, FIG. 10 depicts a surface enhanced Raman spectroscopy sensor that includes opposing substrates 400 and 420. For this example, nanoposts 402 are disposed on the substrate 400 that may be randomly or orderly in a periodic or aperiodic arrangement. The nanoposts may be formed from a dielectric (silicon dioxide, or a polymer, for example) or semiconductor material. As shown, metallic nanodots 404 may be disposed on the distal ends of the nanoposts 402 or the nanoposts can be coated with a plasmonic metal to form a corresponding enhanced surface. For the opposing substrate 420, a plasmonic metal layer 424 may be deposited to form the opposing enhanced surface. Thus, many variations are contemplated, which are within the scope of the appended claims.

Referring back to FIG. 1, as examples, the actuator 50 may be a microelectromechanical system (MEMS)-based actuator; an actuator that uses thermal expansion, such as thermal expansion pillars, for purposes of expanding and contracting the intersurface spacing G based on a current supplied to the actuator 50; a piezoelectric-based pillars that expand and contract in response to a voltage that is applied to a piezoelectric material; a pneumatic-based actuator that uses, for example, a vacuum to expand and contract the intersurface spacing G; a bimetallic-based actuator that uses the different expansions of different metals to expand and contract the intersurface spacing G; a memory metal-based actuator, such as a spring.

In accordance with some implementations, the SERS sensor may include one or multiple compliant members, which provide a certain degree of flexibility to accommodate non-ideal planar surfaces. In this regard, the substrate surfaces on which the opposing enhanced surfaces are formed may not be strictly flat. The compliant member(s) accommodate variances from strictly planar surfaces for purposes of causing the opposing enhanced surfaces to generally conform to each other.

The compliant member may be a polymer post, such as a nanowire-type post 452, on which nanodots 452 are formed, as depicted in FIG. 11. Referring to FIG. 11, the nanowires 452 may be randomly oriented or orderly oriented. The nanowires 452, in general, are not parallel to the surface normal of the substrate surface, as shown, which allows the nanowires 452 to flex when in contact with the opposing surface. In addition, any of the substrates 20 (FIG. 2), 30 (FIG. 2), 147 (FIG. 6), 154 (FIG. 6), 200 (FIG. 6), 210 (FIG. 7), 248 (FIG. 8), 253 (FIG. 8), 300 (FIG. 9), 320 (FIG. 9), 400 (FIGS. 10) and 420 (FIG. 10) may be compliant and as such, may be made of a compliant material, such as a polymer, a thin glass, quartz, a semiconductor (silicon, for example) or a thin metal foil, to name a few examples.

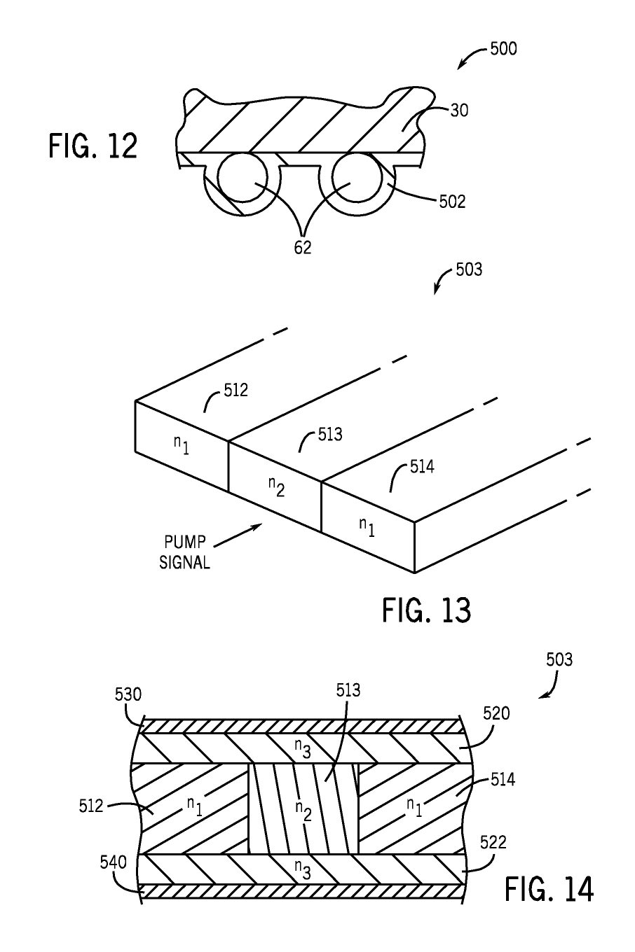

Referring to FIG. 12, in accordance with some implementations, a SERS sensor 500 may include a layer 502 to further prevent oxidation/sulfidization of underlying nanodots 62. Moreover, the layer 502 may prevent the nanostructures (nanodots, for example) on opposing surfaces from adhering or at least lessening the degree of adherence when the actuator 50 increases the intersurface spacing G. As examples, the layer 502 may be formed by, for example, atomic layer deposition (ALD) and may be, as examples, a fluorinated polymer, a thin metal (silver, for example), a thin glass. Other implementations are contemplated and are within the scope of the appended claims. For example, in accordance with further implementations, different plasmonic metals may be used on the opposing enhanced surfaces, for purposes of prevent the enhanced surfaces from adhering to each other. For example, in accordance with some implementations, gold may be used for a nanostructure/layer on one enhanced surface, with silver being used for the nanostructure/layer on the opposing enhanced surfaces.

As another example, the SERS sensor may employ waveguides that are patterned in two dimensions to allow more interaction between the pump light and the enhanced surface and generally improve the interaction of the pump signal with the analyte. Patterned waveguides may also be used for improving both the interaction of the pump light with the analyte/plasmonic structures and collection of the Raman signal. For example, the size/number of detectors otherwise used for collecting the signal may be reduced. Waveguides also allow discrimination of the part of the sample providing the signal came, which may be useful if different areas are functionalized to detect different analytes.

Referring to FIGS. 13 and 14, waveguide channel 513 may be formed in a SERS sensor 503 for purposes of routing incident signals to multiple sets of enhanced surfaces. As shown, waveguide cladding 512 (for one set of opposing enhanced surfaces (not shown)) and 514 (for another set of opposing enhanced surfaces (not shown)) are formed in parallel from a material having a refractive index n₁, and are separated by a material having a refractive index n₂. The waveguide channels 512 and 514, in turn, are disposed between upper 520 and lower 522 layers having a refractive index n₃. In general, the following relationship holds: n₂<n₁ n₃. Moreover, as illustrated in FIG. 14, diffusive mirror layers may be disposed above (diffusive mirror layer 530) and below (diffusive mirror layer 540) the n₃ layers 520 and 522 for purposes of enhancing light recycling.

A SERS sensor may, in accordance with further implementations, have a single substrate that forms the opposing surfaces that are separated by the intersurface spacing G. For example, in accordance with some implementations, a relatively flexible single substrate may be folded in half to form the opposing surfaces. Thus, the opposing surfaces may be formed from one or multiple substrates, depending on the particular implementation.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A sensor for surface enhanced Raman spectroscopy (SERS), the sensor comprising:
a first surface;
a second surface; and
an actuator to adjust an intersurface spacing between the first and second surfaces to establish a first distance between the first and second surfaces to contain an analyte and a second distance between the first and second surfaces to allow the analyte to be released from containment.

2. The sensor of claim 1, further comprising a nanostructure to form at least part of the first surface.

3. The sensor of claim 2, wherein the nanostructure comprises a nanostructure selected from the group consisting of a nanowire, a nanopost, a roughened surface and a quantum dot.

4. The sensor of claim 2, further comprising an additional nanostructure to form at least part of the second surface.

5. The sensor of claim 1, further comprising a compliant layer disposed on at least one of the first and second substrates to cause the first and second surfaces to conform to each other.

6. The sensor of claim 5, wherein the compliant member comprises at least one of a film and a nanostructure.

7. The sensor of claim 1, further comprising:
a nanostructure; and
a metal disposed on the nanostructure to form one of the first and second surfaces.

8. The sensor of claim 1, further comprising:
a nanostructure; and
a dielectric layer disposed on the nanostructure to form one of the first and second surfaces.

9. The sensor of claim 1, wherein the actuator comprises an actuator selected from the group consisting of a piezoelectric-based actuator, a memory metal-based actuator, a microelectromechanical system (MEMS)-based sensor, a pneumatic-based actuator, a bimetallic-based actuator and a thermal expansion-based actuator.

10. An apparatus for surface enhanced Raman spectroscopy (SERS), the apparatus comprising:
a waveguide to direct incident energy; and
a structure to produce a Raman signal in response to incident energy comprising:
a first enhanced surface;
a second enhanced surface; and
an actuator to adjust an intersurface spacing between the first and second enhanced surfaces to establish a first distance between the first and second enhanced surfaces to contain an analyte and a second distance between the first and second enhanced surfaces to allow the analyte to be released from containment.

11. The apparatus of claim 10, wherein the structure further comprises:
a first substrate on which the first enhanced surface is formed; and
a second substrate other than the first substrate on which the second enhanced surface is formed.

12. The apparatus of claim 11, wherein the structure further comprises:
a substrate on which the first and second enhanced surfaces are formed.

13. A method for surface enhanced Raman spectroscopy (SERS), the method comprising:
forming a nanostructure to create a an enhanced first surface; and
disposing an actuator between the first surface and a second surface to regulate an intersurface spacing between the first and second surfaces to selectively allow an analyte to be contained between the first and second surfaces and released from containment.

14. The method of claim 13, further comprising forming an additional nanostructure to form the second surface.

15. The method of claim 13, further comprising forming a compliant member to enhance compliance of the first surface to the second surface.

16. The method of claim 15, wherein forming the compliant member comprises depositing a film or forming a compliant nanostructure.

17. The method of claim 13, further comprising depositing a metal on the nanostructure.

18. The method of claim 17, wherein the metal comprises a metal selected from gold, copper, silver, nickel, paladium, aluminum and platinum.

19. The method of claim 17, further comprising forming a dielectric layer on the metal.

20. The method of claim 13, further comprising forming the second surface comprising forming one of a nanowire, a nanopost, a roughened surface and a nanodot.
